(19) United States
(12) Patent Application Publication
(10) Pub. No.: US 2021/0227023 A1
(43) Pub. Date: Jul. 22, 2021

(54) SYSTEM AND METHOD FOR MANAGING TAGGED VIRTUAL INFRASTRUCTURE OBJECTS

(71) Applicant: VMware, Inc., Palo Alto, CA (US)

(72) Inventors: Maarten WIGGERS, San Francisco, CA (US); Matthew KIM, San Jose, CA (US)

(73) Assignee: VMware, Inc., Palo Alto, CA (US)

(21) Appl. No.: 16/931,586

(22) Filed: Jul. 17, 2020

Related U.S. Application Data
(63) Continuation-in-part of application No. 16/746,589, filed on Jan. 17, 2020.

(51) Int. Cl. H04L 29/08; G06F 9/455; G06F 9/50

(52) U.S. Cl. CPC H04L 67/1031; H04L 67/1012; G06F 9/45558; G06F 2009/45591; G06F 2009/45595; G06F 2009/4557; G06F 9/5077

(57) ABSTRACT

An example method for an infrastructure management server to manage virtual infrastructure objects in a cluster is disclosed. The example method includes configuring the infrastructure management server to perform a function on the virtual infrastructure objects in the cluster, identifying a set of virtual infrastructure objects out of the virtual infrastructure objects that are tagged, identifying a customized policy associated with the first set of virtual infrastructure objects, and modifying the function based on the customized policy.

### CROSS-REFERENCE TO RELATED APPLICATION

This application is a continuation-in-part under 35 U.S.C. § 120 of U.S. patent application Ser. No. 16/746,589, filed Jan. 17, 2020, which is incorporated by reference in its entirety.

### BACKGROUND

When creating a group of virtual machines, a common set of virtual machine configurations or services may be deployed to each of the virtual machines in a virtual machine group. However, in some special scenarios, having the same set of virtual machine services for all the virtual machines in the virtual machine group may not be ideal, as some of the virtual machines may need to have specific services deployed (e.g., services to reduce the workload of the virtual machine group) while the other virtual machines may require just certain common services.

In addition, as more and more virtual machines are deployed to more and more hosts, monitoring, configuring, and managing all these virtual machines and hosts becomes increasingly difficult and burdensome.

### BRIEF DESCRIPTION OF THE DRAWINGS

FIG. 1 illustrates a block diagram of an example virtualized computing environment that can be utilized to configure virtual machines with tags, according to one or more embodiments of the present disclosure.

FIG. 2 illustrates multiple GUI windows configured to create policies, assign tags, and display real-time feedback information, according to one or more embodiments of the present disclosure.

FIG. 3 illustrates example GUI elements for managing multiple policies, according to one or more embodiments of the present disclosure.

FIG. 4 shows a flow diagram illustrating a process to create and manage policies with GUI elements, according to one or more embodiments of the present disclosure.

FIG. 5 shows a flow diagram illustrating one process for an infrastructure management server to manage tagged virtual infrastructure objects in a cluster, according to one or more embodiments of the present disclosure.

FIG. 6 shows a flow diagram illustrating another process for an infrastructure management server to manage tagged virtual infrastructure objects in a cluster, according to one or more embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

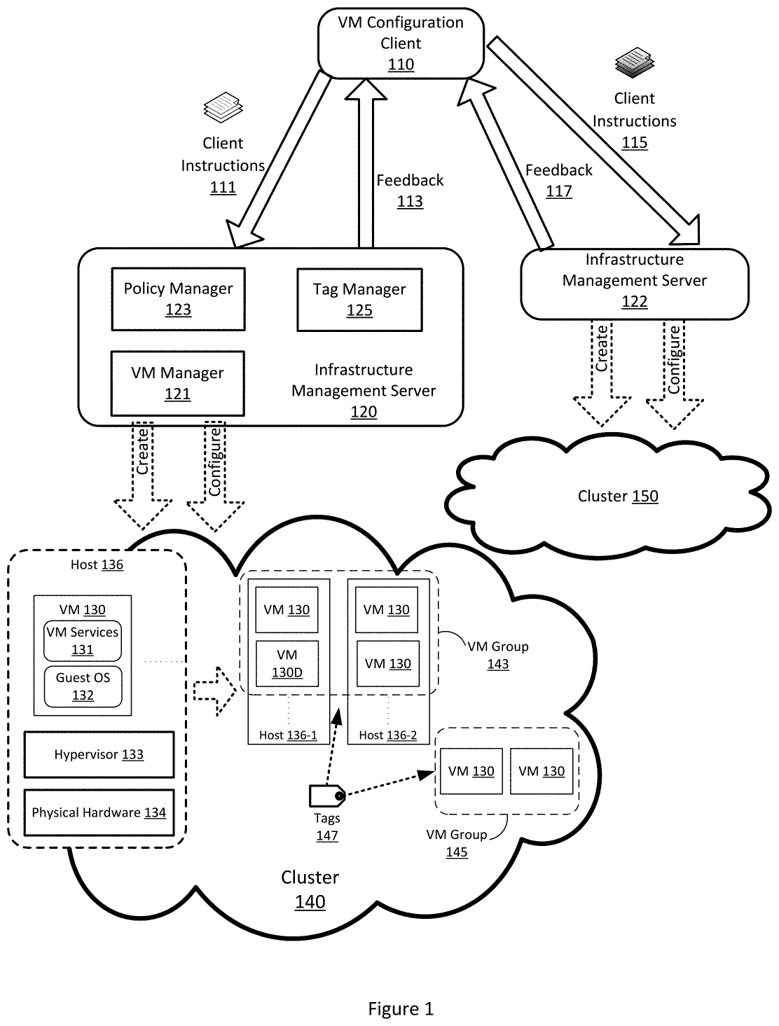

FIG. 1 illustrates a block diagram of an example virtualized computing environment that can be utilized to configure virtual infrastructure objects with tags, according to one or more embodiments of the present disclosure. For clarity, subsequent discussions mainly focus on one example of virtual infrastructure objects (e.g., virtual machines or VMs) and one example of a resource provider (e.g., hosts). The methods and systems described below are applicable to other virtual infrastructure objects, such as virtual disks, and their underlying physical resources, such as disks. The methods and systems described below also are applicable to other resource providers, such as datastores. Throughout this disclosure, a “tag” may be a label that can be applied to objects in cluster 140 of FIG. 1, in order to make it easier to categorize, sort, and search for these objects. Some examples of such objects include the aforementioned virtual infrastructure objects (e.g., VMs, virtual disks, etc.) and physical objects (e.g., hosts, disks, etc.) Alternatively, a tag may store the common metadata (e.g., physical location, hardware configuration, etc.) of the objects. Further, a “VM tag” may be a label that can be assigned to multiple VMs, each of which shares a common characteristic among themselves. Tags assigned to virtual infrastructure objects are referred to as virtual infrastructure object tags. A VM tag is one example of a virtual infrastructure object tag. Tags assigned to physical objects are referred to as physical object tags. A “host tag” is one example of a physical object tag and may be assigned to a set of hosts that can be grouped together.

The virtualized computing environment of FIG. 1 includes multiple clusters (e.g., 140 and 150). As illustrated, each cluster 140 is represented by the aggregate computing and memory resources of multiple hosts (e.g., host 136-1 and host 136-2, which are collectively referred to as hosts 136), and each host 136 may include suitable virtualization software (e.g., hypervisor 133) and physical hardware 134 to support various VMs 130. Physical hardware 134 may include components, such as central processing unit(s) (CPU(s)) or processor(s); memory; physical network interface controllers (PNICs); and storage device(s), etc. In practice, cluster 140 may include any number of hosts (also known as a “host computers,” “host devices,” “physical servers,” “server systems,” “transport nodes,” etc.), where each host may support tens or hundreds of VMs.

Physical hardware 134 of hosts 136 may be configured to support functions of VMs 130 and/or infrastructure management server 120. The terms, “infrastructure management servers” and “IF management servers” are used interchangeably throughout the written description and the figures. In some embodiments, the memory and/or storage device(s) in physical hardware 134 has non-transitory computer-readable storage medium with a set of instructions for the CPU or processor to execute. Physical hardware 134 may also include physical network interface controllers configured to transmit and receive messages in cluster 140.

For each VM 130, guest operating system (OS) 132 may be configured to support applications and services such as VM services 131. VM services 131 may include any network, storage, image, or application services that can be executed on VM 130 based on OS 132. Each VM 130 may be used to provide various cloud services in cluster 140.

A VM configuration client may interact with multiple infrastructure management servers to configure one or more VMs in multiple VM clouds/clusters. To illustrate, VM configuration client 110 may interact with infrastructure management servers 120 and 122 to configure the VMs in VM clouds/clusters 140 and 150. VM configuration client 110 may support a graphic user interface (GUI), which allows a user (e.g., an administrator) to initiate the creating and configuring of the VMs in particular clouds/clusters by selecting a infrastructure management server and transmitting one or more client instructions to the selected infrastructure management server. For example, VM configuration client 110 may select infrastructure management server 120 and transmit client instructions 111 to infrastructure management server 120 to interact with VMs 130 in cluster 140. With the selected infrastructure management server 120, VM configuration client 110 may also display up-to-date information on its GUI based on real-time feedback 113 that it receives from infrastructure management server 120. On the other hand, if VM configuration client 110 selects infrastructure management server 122, then it can transmit client instructions 115 to infrastructure management server 122 to interact with the VMs in cluster 150 and display up-to-date information on its GUI based on real-time feedback 117 that it receives from infrastructure management server 122.

In some embodiments, VM configuration client 110 may be a client software application installed on a client computer (e.g., a personal computer or workstation). VM configuration client 110 may also be a web-based application operating in a browser environment. VM configuration client 110 may interact with infrastructure management server 120 and infrastructure management server 122 via Transmission Control Protocol/Internet Protocol (TCP/IP), Hypertext Transfer Protocol (HTTP), or any other feasible network communication means. Alternatively, VM configuration client 110 may be implemented as a software/hardware module executing directly on infrastructure management server 120.

In some embodiments, infrastructure management server 120 may be configured to manage cluster 140, which includes, among other components, one or more VMs (e.g., VMs 130), one or more VM groups (e.g., VM group 143), and/or one or more hosts (e.g., hosts 136). Cluster 140 may support a network-based computing architecture that provides a shared pool of computing resources (e.g., networks, data storages, applications, and services) on demand. Infrastructure management server 120 may be configured to provide provisioning, pooling, high-availability, automation, migration of VMs, and resource balancing and allocation capabilities to the computing resources supporting cluster 140. Infrastructure management server 122 and cluster 150 may also be set up in the aforementioned manner similar to infrastructure management server 120 and cluster 140, respectively.

In some embodiments, infrastructure management server 120 may include VM manager 121 to manage the creating and configuring of cluster 140, as well as the VMs 130 and VM groups 143 and 145 in cluster 140. A “VM group” may include multiple hosts (e.g., host 136-1 and host 136-2 as shown in FIG. 1) and the associated VMs 130 with shared resources and shared management interfaces. VM manager 121 may provide centralized management capabilities, such as VM creation, VM configuration, VM updates, VM cloning, VM high-availability, VM resource distributions, etc.

In some embodiments, infrastructure management server 120 may include policy manager 123 for the creating and applying of policies to one or more VMs and VM groups in cluster 140. A “policy” may refer to a configuration mechanism to specify how VMs 130 and hosts in a resource pool (e.g., VM group) should be configured. Each policy may be available to all clusters that meet certain requirements (e.g., clusters with particular tags, particular matching names, etc.) In some instances, a policy may be an affinity policy, which may correspond to one or more restrictions to be applied to VMs 130 and hosts during installation and configuration. Further, an affinity policy may be a “positive-affinity” or an “anti-affinity” policy. A positive-affinity policy may dictate that a certain VM 130 should be installed on a particular host, or multiple VMs 130 should be installed on a common host. An anti-affinity policy may indicate that multiple VMs 130 should NOT share a common host and should each be installed onto a different host.

For example, VM group 143 may be configured with positive-affinity policies. In this case, VM manager 121 may create and configure the VMs in VM group 143 together on common or dedicated hosts. VM group 145 may be configured with anti-affinity policies. In this case, VM manager 121 may create and configure each of the VMs in VM group 145 onto a corresponding host that is not shared by any other VMs in VM group 145. Thus, the positive-affinity policies and anti-affinity policies may cause VM manager 121 to keep VMs 130 either together or separated, in order to reduce traffic across the networks or keep the virtual workload balanced in cluster 140.

In some embodiments, policy manager 123 may apply one or more VM-Host affinity policies to VM group 143. A “VM-Host affinity policy” may describe a relationship between a category of VMs and a category of hosts. To place VMs or hosts in categories, they can be assigned with tags (e.g., tags 147), and the tags are then grouped in categories. Throughout this document, categories of objects (e.g., VMs, hosts) are used interchangeably with categories of the tags assigned to these objects.

For example, VM-Host affinity policies may be applicable to some VMs and hosts when host-based licensing requires VMs that are running certain applications to be placed on hosts that are licensed to run those applications. VM-Host affinity policies may also be useful when VMs with workload-specific configurations require placement on hosts that have certain characteristics. Based on a VM-Host affinity policy, VM manager 121 may deploy those VMs on hosts both of which are covered by the policy.

In some embodiments, policy manager 123 may apply one or more VM-VM affinity policies to VM group 143. A “VM-VM affinity policy” may describe a relationship between members of a category of VMs. In other words, a VM-VM affinity policy may establish an affinity relationship between VMs in a given category. VM-VM affinity policies may be applicable to two or more VMs in a category that can benefit from locality of data reference or where placement on the same host can simplify auditing. Policy manager 123 may create a VM-VM affinity policy to deploy all VMs in the category covered by the policy on the same host.

In some embodiments, policy manager 123 may apply one or more VM-Host anti-affinity policies to VM group 145. A “VM-Host anti-affinity policy”, which describes a relationship between a category of VMs and a category of hosts, may be used to avoid placing VMs that have specific host requirements (such as a GPU or other specific hardware devices, or capabilities such as IOPS control), on hosts that can't support those requirements. Based on a VM-Host anti-affinity policy, VM manager 121 and policy manager 123 may deploy VMs on hosts according to the policy, and may prevent/block those deployments that may violate this policy.

In some embodiments, policy manager 123 may apply one or more VM-VM anti-affinity policies to VM group 145. A “VM-VM anti-affinity policy”, which describes a relationship among a category of VMs, may discourage placement of VMs in the same category on the same host. VM manager 121 and policy manager 123 may place VMs running critical workloads on separate hosts, so that the failure of one host does not affect other VMs in the category.

In some embodiments, infrastructure management server 120 may further include tag manager 125 to use tags for configuring one or more VMs and VM groups in cluster 140. A “tag category” may be used to group multiple tags together, or to define how tags can be applied to objects. For example, when multiple policies, VMs, and hosts share a common tag, this common tag is used to group such entities. Further, a “VM tag category” may group a set of VM tags, and a “host tag category” may group a set of host-related tags such as VM-host affinity tags.

In some embodiments, based on client instructions 111 from VM configuration client 110, VM manager 121 may interact with tag manager 125 to create or delete tags from entities. Further, when client instructions 111 are to delete a tag, tag manager 125 may interact with policy manager 123 to remove all policies that are associated with the to-be-deleted tag.

In some embodiments, a user may interact with VM configuration client 110 to perform various VM configuration operations such as VM creation, policy creation, and tag deletions, etc. VM configuration client 110 may transmit user initiated operations as one or more client instructions 111 to infrastructure management server 120. VM manager 121, policy manager 123, and tag manager 125 may perform their respective operations based on the received client instructions 111, and may transmit feedback 113 back to VM configuration client 110.

In some embodiments, the GUI of the VM configuration client 110 may receive a command from the user to assign one or more tags to an already existing VM. These one or more tags may already be associated with one or more policies. In order to allow the user to receive real-time feedback, VM configuration client 110 may request (via client instructions 111) infrastructure management server 120 to provide information related to tags and their respective associated policies, and return such information as real-time feedback 113 to VM configuration client 110. VM configuration client 110 may display the real-time feedback on its GUI.

In some embodiments, before a user may delete a tag via the GUI of the VM configuration client 110, the tag may already be associated with one or more policies. In order to allow the user to receive real-time feedback, VM configuration client 110 may request (via client instructions 111) infrastructure management server 120 to provide information related to the tag and their respective associated policies, and return such information as feedback 113 to VM configuration client 110. Then, VM configuration client 110 may display the real-time feedback on its GUI, notifying the user of the policies that may be deleted along with the tag-deletion operation. Thus, the above approach ensures that real-time feedback 113 of the various operations is presented to the user before the user invokes these operations via the GUI of VM configuration client 110. The details of the creating and configuring VMs with policies and tags are further described below.

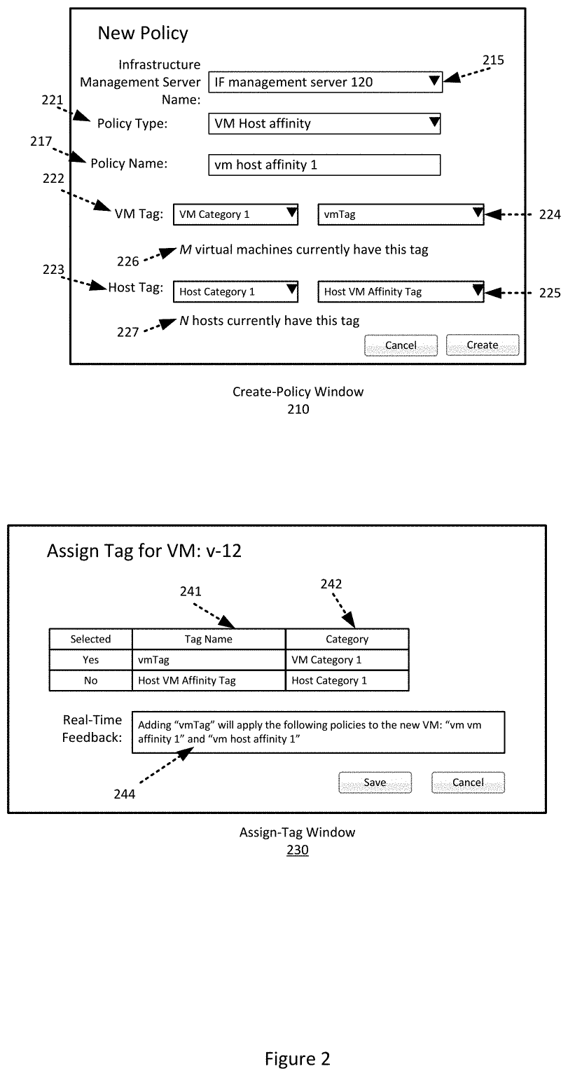

FIG. 2 illustrates multiple GUI windows configured to create policies, assign tags, and display real-time feedback information, according to one or more embodiments of the present disclosure. Specifically, an infrastructure management server (e.g., infrastructure management server 120 or infrastructure management server 122 of FIG. 1) that interacts with a cluster (similar to cluster 140 or cluster 150 of FIG. 1) may receive from a VM configuration client (similar to VM configuration client 110 of FIG. 1) a set of client instructions. In some embodiments, the VM configuration client may support GUI elements such as create-policy window 210 and assign-tag window 230.

For simplicity, the operations associated with these GUI windows illustrated in FIG. 2 are discussed in conjunction with FIG. 1.

Creation of a New Policy

In some embodiments, create-policy window 210 corresponds to a GUI element for creating a new policy in the cluster (e.g., cluster 140 or cluster 150). Specifically, via create-policy window 210, a user may select one of the infrastructure management servers that VM configuration client 110 has access to and specify various values and information for a new policy. Afterward, the user may click on the “create” button, which causes VM configuration client 110 to transmit client instructions 111 to the selected infrastructure management server, which may in turn generate the requested policy accordingly.

In some embodiments, for all the infrastructure management servers that VM configuration client 110 has access to, they are presented as selectable options in server selection drop-down menu 215. Suppose the user selects infrastructure management server 120 for cluster 140 via server selection drop-down menu 215, the user may then enter “vm host affinity” via text field 217 in create-policy window 210 as the name of the new policy and may further assign the new policy with one of the policy types, each of which is selectable via policy type drop-down menu 221. Some example policy types may include, without limitation, “VM-Host Affinity”, “VM-VM Affinity”, “VM-Host Anti-affinity”, “VM-VM Anti-affinity,” “Disable DRS vMotion,” and “Evacuation by vMotion.”

Suppose the new policy corresponds to the selected type of VM-Host Affinity. The user may associate this new policy with at least one VM from the cluster 140 with one or more VM tags assigned to it. In some embodiments, after having selected a VM tag category via VM category drop-down menu 222 and a VM tag via VM tag drop-down menu 224 in create-policy window 210, all the VMs that meet the selected criteria are counted in real-time and displayed in create-policy window 210 in first object count 226 (e.g., M virtual machines currently have this tag). These VMs also become associated with this new policy after the user selects “Create.”

In some embodiments, after having selected a host tag category via host category drop-down menu 223 and a host tag via host tag drop-down menu 225 in create-policy window 210, all the hosts that meet the selected criteria are counted in real-time and displayed in create-policy window 210 in second object count 227 (e.g., N hosts currently have this tag). These hosts also become associated with this new policy after the user selects “Create.” In some embodiments, the selection of “Create” may transmit the selected information to infrastructure management server 120, which may then utilize policy manager 123 to create and save the new policy.

In some embodiments, after having selected the VM tag category, the VM tag, the host tag category, and the host tag, VM configuration client 110 may transmit client instructions 111 with the selected items to infrastructure management server 120, which may utilize its tag manager 125 to retrieve relevant tag categories and tags. Then infrastructure management server 120 may return these tag categories and tags as feedback 113 to VM client configuration client 110, which presents the information via its GUI.

Tag Assignment

In some embodiments, VM configuration client 110 may include assign-tag window 230, which allows a user to select one or more tags to be assigned to the created VM. As illustrated in FIG. 2, assign-tag window 230 is for an already created VM identified as “v-12.” Assign-tag window 230 may load all available tags from infrastructure management server 120 and present these tags in tag names 241 and/or in categories 242. In other words, the user may either pick from all the available names 241, or browse by categories 242, until identifying the suitable tags for the new VM. Alternatively, drop-menus with selectable choices of names and categories may be presented to the user.

In some embodiments, each newly created VM may be assigned with one or more tags. As illustrated in FIG. 2, assign-tag window 230 presents two available tags for assignment to the new VM. One VM tag with the name of “vmTag” and the category of “VM category” may be assigned to one or more VMs or one or more policies associated with certain VMs. One host tag with the name of “Host VM Affinity Tag” and the category of the “Host Category” may be assigned to one or more hosts or one or more policies associated with certain hosts.

In some embodiments, the user may make a GUI selection on assign-tag window 230 and “select” no-tag, one-tag, or two-tags for the new VM. When the user makes a single GUI selection in assign-tag window 230, in order to provide real-time feedback to the user, prior to the user invoking any additional GUI operations, VM configuration client 110 may transmit client instructions 111 to infrastructure management server 120. Client instructions 111 may include, without limitation, the identification of the selected tag(s). After having received client instructions 111, infrastructure management server 120 may retrieve a set of policies that are associated with the selected tag(s), and return the retrieved set of policies as feedback to VM configuration client 110.

In some embodiments, assign-tag window 230 may display the set of policies from the feedback 113 in a “real-time feedback” GUI element such as message 244. The information in message 244 may show that there are two policies currently associated with the VM tag “vmTag.” By displaying real-time information of the policies that may apply to the new VM with the selected tag, the user can quickly grasp the impact of his or her proposed actions, thereby allowing a more efficient and accurate configuration of the new VM.

Deletion of a Tag

In some embodiments, VM configuration client 110 includes additional GUI elements to support a tag deletion process. Specifically, in the tag deletion process, a delete-tag window (not shown in FIG. 2) may be presented to a user to select a specific tag for deletion. Since the specific tag may be associated with multiple policies, the deletion of the specific tag may also affect all the associated policies. Thus, the delete-tag window may display in real-time a warning of possible impacts of the tag deletion process before the user proceeds to complete the deletion process.

In some embodiments, the delete-tag window may display the set of policies that are associated with the tag to be deleted in a real-time GUI element similar to message 244. The information in message 244 may show that for the tag to be deleted, there are associated policies that will also be affected. By providing this real-time feedback, the user can quickly grasp the impact of his or her actions before proceeding further.

Management of Policies

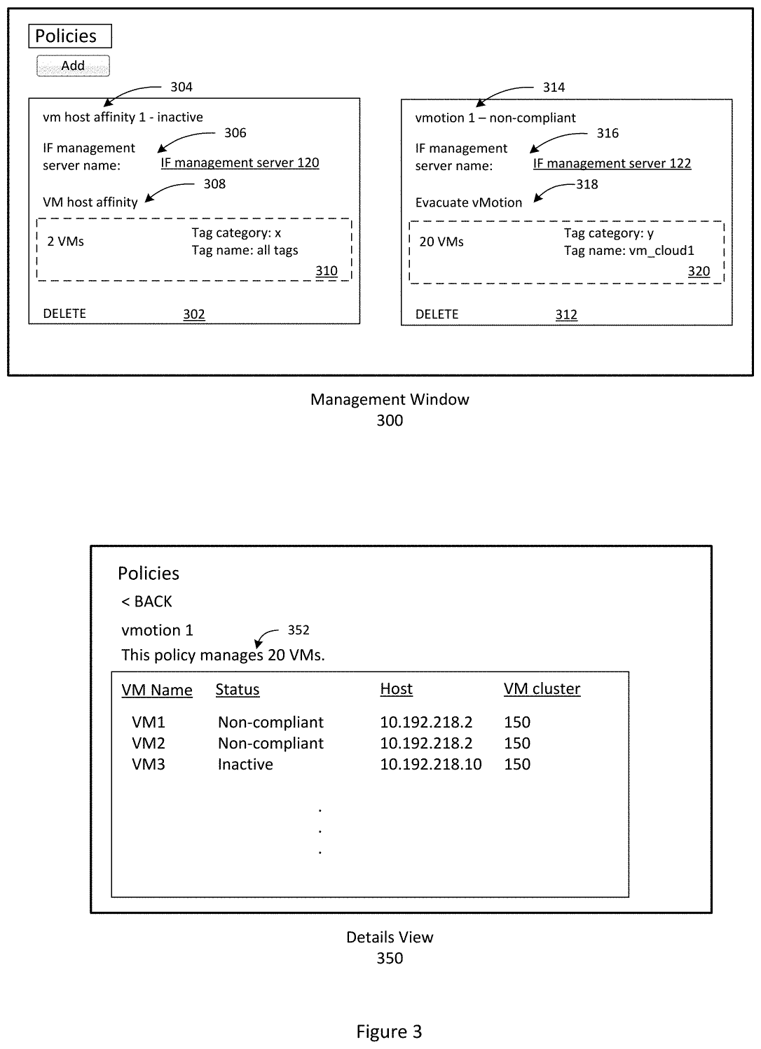

After the creation of VMs and policies and the assignment of tags, VM configuration client 110 includes additional GUI elements to support management of policies. FIG. 3 shows example GUI elements for managing multiple policies, according to one or more embodiments of the present disclosure.

In particular, management window 300 in FIG. 3 illustrates two GUI elements for the two policies that have been created. Management window 300 also includes an “Add” button to add a new policy. Policy 302 has policy name 304 (e.g., “vm host affinity 1”), selected infrastructure management server name 306 (e.g., infrastructure management server 120), selected policy type 308 (e.g., “VM host affinity”), and message 310. In some embodiments, message 310 displays real-time information pertaining to the number of VMs associated with policy 302 that currently have the specified tag category and tag name. For instance, as shown in FIG. 3, message 310 displays that 2 VMs have the specified tag category of “x” and tag name of “all tags.”

In addition, suppose the status of each of these 2 VMs is inactive. The status information of the VMs is then aggregated for policy 302, and the aggregated status information is then presented as “inactive” in text, image, or a combination of text and image. In FIG. 3, the aggregated status information is presented as “inactive” in text only.

Similarly, compute 312 also has policy name 314 (e.g., “vmotion 1”), selected management server name 316 (infrastructure management server 122), selected policy type 318 (e.g., “Evacuate vMotion”), and message 320. In some embodiments, each of the policy name, selected infrastructure management server name, and VM policy type may be a selectable GUI item. For example, in response to a user's selection of policy name 314, “vmotion 1,” a different GUI element, details view 350 is displayed.

In details view 350, in addition to real-time object count 352, which indicates the number of VMs the policy “vmotion 1” regulates, additional information about the VMs is presented. In some embodiments, the names of the VMs, their respective status, the identities of the hosts supporting the VMs, and the VM cluster that the VMs belong to are presented. By presenting such detailed information about the VMs to a user, the user is able to identify possible issues and manage VM clusters more easily.

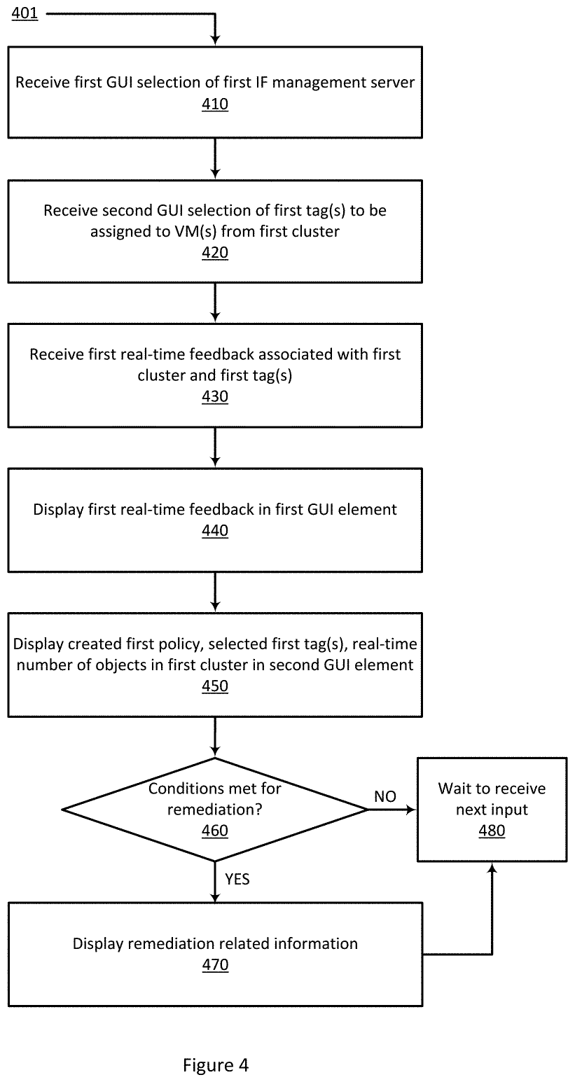

FIG. 4 shows a flow diagram illustrating a process to create and manage policies with GUI elements, according to one or more embodiments of the present disclosure. Process 401 may set forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 4 may be practiced in various implementations.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

Using FIGS. 1, 2, and 3 as an example, at block 410, a VM configuration client (e.g., VM configuration client 110) may receive a first GUI selection (e.g., a selection of an item in server selection drop-down menu 215 in create-policy window 210) of a first infrastructure management server (e.g., infrastructure management server 120). With the selected server, the first infrastructure management server may send the VM configuration client a set of available first tags from a first cluster (e.g., cluster 140) that it has access to.

At block 420, the VM configuration client receives a second GUI selection (e.g., a selection of an item in VM category drop-down menu 222, VM tag drop-down menu 224, host category drop-down menu 223, or host tag drop-down menu 225) of first tag(s) (e.g., VM tags and/or host tags), wherein the selected tags are to be assigned to one or more VMs from the first cluster.

At block 430, the VM configuration client receives first real-time feedback associated with the first cluster and the first tag(s) from the infrastructure management server.

At block 440, the VM configuration client displays the first real-time feedback (e.g., first object count 226 and/or second object count 227) in a first GUI element (e.g., create-policy window). With the displayed real-time feedback associated with creating a first policy, a user is able to make informed decisions regarding the creation and management of this first policy.

After having created the first policy, at block 450, the VM configuration client may display at least the first policy, the selected first tag(s), and the first real-time feedback (e.g., real-time number of objects in cluster 140 that have the selected first tag(s) and are regulated by the first policy) in a second GUI element (e.g., management window 300).

In some embodiments, the VM configuration client may similarly retrieve the one or more previously created policies and also display such policies in the second GUI element.

At block 460, the conditions for remediation are checked, either by the administrator using the VM configuration client or by the selected first infrastructure management server. To illustrate, suppose the first policy is a VM-VM anti-affinity policy, and suppose 16 VMs are displayed in the second GUI element to be affected in block 450. However, suppose these 16 VMs are actually on the same host, against the VM-VM anti-affinity policy. In this situation, conditions for remediation have been met, because 15 of the 16 VMs need to be migrated to another host to comply with the VM-VM ani-affinity policy.

In another example, suppose the administrator reviews the information displayed in the second GUI element in block 450 and recognizes discrepancies (e.g., the displayed number of objects is significantly higher than expected). The conditions for remediation have also been met, because the recognized discrepancies need to be reconciled.

If the conditions for remediation are met, process 401 proceeds to block 470. At block 470, the VM configuration client may display remediation related information, such as the results of the remediation or the potential impact for performing remediation. Using the above example of migrating 15 VMs, suppose the potential impact for migrating all 15 VMs at once is significant and is shown to the administrator, the administrator may decide to consider alternative schemes, such as migrating the 15 VMs before creating the VM-VM ani-affinity policy, removing the tag from half of the VMs and retagging these VMs after the first batch of the migration completes, or other remediation schemes.

On the other hand, if the conditions for remediation have not been met, then process 401 proceeds to block 480. At block 480, the VM configuration client waits to receive the next input, either from an administrator or from the selected first infrastructure management server.

Management of Virtual Infrastructure Objects Under Certain Conditions

Conventionally, infrastructure management server 120 of FIG. 1 may be configured to perform certain functions for cluster 140. For example, infrastructure management server 120 may be configured to automatically balance workloads in cluster 140 by identifying the host (e.g., host 136-1) in cluster 140 that has exhausted its resources and causing the VM 130s running on host 136-1 to be migrated to another host that still has available resources (e.g., host 136-02). To balance workloads “automatically” generally refers to not requiring any manual input from a user, such as a system administrator. In addition to balancing workloads, infrastructure management server 120 may also be configured to prevent evacuating a host in cluster 140 under certain conditions. However, some of the VM 130s sometimes may be critical and should be processed differently. One approach to address such situations is by identifying these critical VMs and making use of their associated policies to modify how infrastructure management server 120 performs its functions.

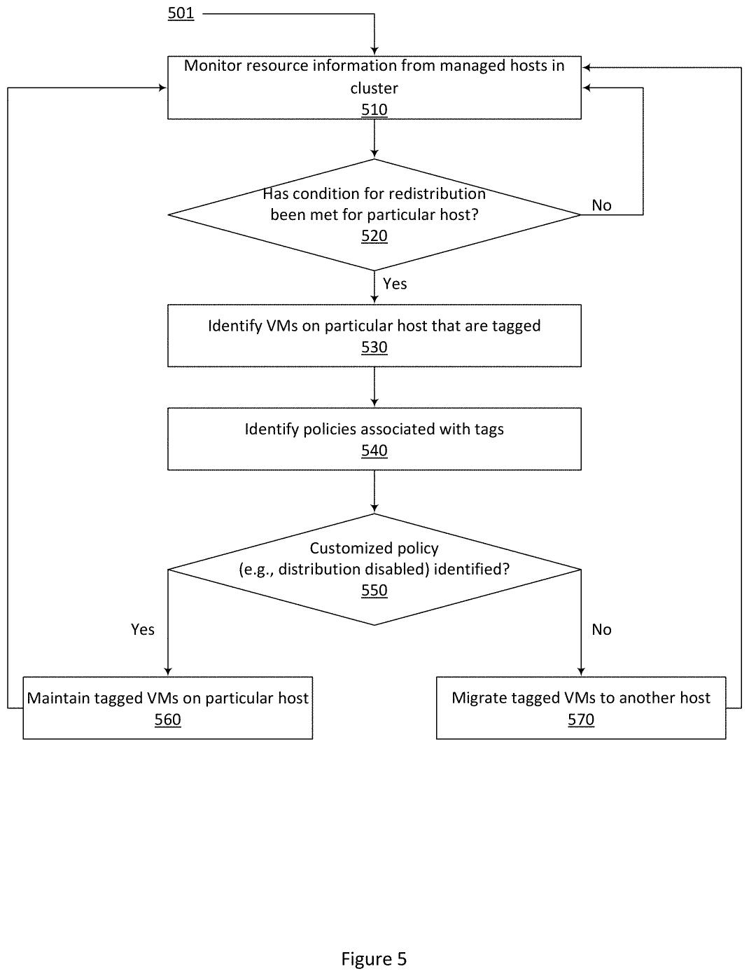

FIG. 5 shows a flow diagram illustrating one process for an infrastructure management server to manage tagged virtual infrastructure objects in a cluster, according to one or more embodiments of the present disclosure. Process 501 may set forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 5 may be practiced in various implementations.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

As shown in FIG. 1, VM 130D in VM group 143 may have two different tags. With the first tag, indicating the membership of VM 130D in VM group 143, policy manager 123 may apply the aforementioned VM-Host affinity policy to VM group 143, so that the VMs 130 in VM group 143 can run on hosts 136-1 and 136-2. With the second tag, policy manager 123 may apply a customized policy (e.g., “distribution disabled” policy) to VM130D.

At block 510, infrastructure management server 120 monitors resource information from managed hosts (e.g., hosts 136) in cluster (e.g., cluster 140).

At block 520, infrastructure management server 120 checks whether any of the managed hosts has met the condition for resource redistribution. For example, the condition may correspond a host can no longer optimally handle its workload due to over-utilization of its processing resources, over-utilization of its memory resources, or exceeding its other physical resource constraints. In another example, the condition may be specified by a policy, dictating a maximum number of virtual infrastructure objects (e.g., VMs) that can run on the managed host.

Suppose host 136-1 is determined to have met the condition, at block 530, infrastructure management server 120 identifies all the VMs 130 running on host 136-1 that are tagged. Here, out of all VMs 130 running on the various hosts 136 in cluster 140, these tagged VMs 130 may be referred to as a first set of virtual infrastructure objects.

At block 540, infrastructure management server 120 identifies the policies that are associated with such tags.

At block 550, infrastructure management server 120 may identify the customized policy, e.g., “distribution disabled” policy, for a tagged VM, e.g., VM 130D, and proceed to maintain tagged VM on host 136-1 in block 560. This tagged VM with the customized policy may belong to a second set of virtual infrastructure objects. This second set is usually a subset of the first set of virtual infrastructure objects but is not required to be. On the other hand, if infrastructure management server 120 does not find the “distribution disabled” policy for the tagged VMs, then the tagged VMs are migrated to another host (e.g., host 136-2) in block 570.

In some embodiments, process 501 may be performed in an iterative manner and without needing any manual input from a user. In other words, after the operations at block 560 or at block 570 are performed, process 501 may start at block 510 again and continue to look for the condition for distribution in block 520. It may take more than one iteration to maintain certain tagged VMs on a particular host.

In summary, by identifying the tagged VM 130D and the customized policy, “distribution disabled,” the resource redistribution function performed by infrastructure management server 120 can be modified to accommodate the particular needs of VM 130D (e.g., maintaining VM 130D on host 136-1).

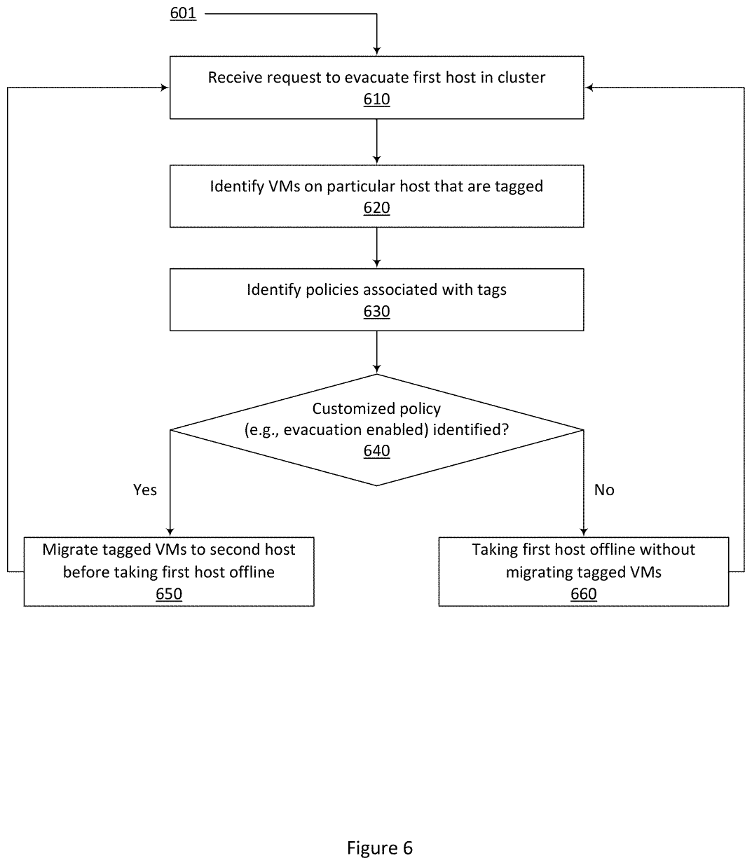

FIG. 6 shows a flow diagram illustrating another process for an infrastructure management server to manage tagged virtual infrastructure objects in a cluster, according to one or more embodiments of the present disclosure. Process 601 may set forth various functional blocks or actions that may be described as processing steps, functional operations, events, and/or acts, which may be performed by hardware, software, and/or firmware. Those skilled in the art in light of the present disclosure will recognize that numerous alternatives to the functional blocks shown in FIG. 6 may be practiced in various implementations.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

At block 610, infrastructure management server 120 receives a request to evacuate a first host (e.g., host 136-1), so that the first host may be taken offline for maintenance. To evacuate a host, in some embodiments, all the running VMs on the host should be migrated to another host (e.g., host 136-1) without disruptions. Specifically, the entire state information of the VMs is moved to host 136-1. Suppose host 136-1 and host 136-2 share storage resources. The associated virtual disk remains in the same location on the shared storage resources.

At block 620, infrastructure management server 120 identifies all the VMs running on host 136-1 that are tagged.

At block 630, infrastructure management server 120 identifies the policies that are associated with such tags.

At block 640, infrastructure management server 120 may identify the customized policy, e.g., the “evacuation enabled” policy, for a tagged VM, e.g., VM 130D, and proceed to migrate the tagged VM from host 136-1 to a second host (e.g., host 136-2) at block 650. As discussed above, in some embodiments, this migration of the tagged VM includes the migration of its entire state to keep the tagged VM running. On the other hand, if infrastructure management server 120 does not find the “evacuation enabled” policy for the tagged VMs, then host 136-1 is taken offline without having migrated the tagged VMs 130 on host 136-1 at block 660.

Similar to process 501 illustrated in FIG. 5, in some embodiments, process 601 may be performed in an iterative manner and without needing any manual input from a user. In other words, after the operations at block 560 or at block 660 are performed, process 601 may start at block 610 again. It may take more than one iteration to migrate certain tagged VMs to a second host.

In summary, by identifying the tagged VM 130D and the customized policy, “evacuation enabled,” the resource redistribution function performed by infrastructure management server 120 can be modified to accommodate the particular needs of VM 130D (e.g., migrating VM 130D to host 136-2 before host 136-1 is taken offline).

Thus, systems and methods for managing virtual infrastructure objects (e.g., VMs) in a cluster have been disclosed. The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations.

In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations. The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term non-transitory computer readable storage medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

We claim:

1. A method for an infrastructure management server to manage virtual infrastructure objects in a cluster, the method comprising:
configuring the infrastructure management server to perform a function on the virtual infrastructure objects in the cluster;
identifying a first set of virtual infrastructure objects out of the virtual infrastructure objects that are tagged;
identifying a customized policy associated with a second set of virtual infrastructure objects out of the first set of virtual infrastructure objects; and
modifying the function based on the customized policy.

2. The method of claim 1, wherein the function is to balance resources in the cluster without any manual input from a user, and the customized policy is to disable distribution of the resources in the cluster.

3. The method of claim 2, in response to a determination that at least one resource provider in the cluster has met a condition for redistribution, wherein modifying the function further comprises:
identifying one or more resource providers in the cluster that support the second set of virtual infrastructure objects; and
maintaining the second set of virtual infrastructure objects on the one or more resource providers.

4. The method of claim 3, wherein the condition for redistribution is based on a physical resource constraint of the identified one resource provider.

5. The method of claim 3, wherein the condition for redistribution is specified by a policy.

6. The method of claim 1, wherein the function is to balance resources in the cluster and to take at least one resource provider offline in the cluster without any manual input from a user, and the customized policy is to enable evacuating the at least one resource provider.

7. The method of claim 6, wherein modifying the function further comprises:
identifying the at least one resource provider in the cluster that supports the second set of virtual infrastructure objects; and
migrating the second set of virtual infrastructure objects to another resource provider in the cluster before taking the at least one resource provider offline.

8. A non-transitory computer-readable storage medium that includes a set of instructions which, in response to execution by a processor of an infrastructure management server, cause the processor to perform a method to manage virtual infrastructure objects in a cluster, wherein the method comprises:
configuring the infrastructure management server to perform a function on the virtual infrastructure objects in the cluster;
identifying a first set of virtual infrastructure objects out of the virtual infrastructure objects that are tagged;
identifying a customized policy associated with a second set of virtual infrastructure objects out of the first set of virtual infrastructure objects; and
modifying the function based on the customized policy.

9. The non-transitory computer-readable storage medium of claim 8, wherein the function is to balance resources in the cluster without any manual input from a user, and the customized policy is to disable distribution of the resources in the cluster.

10. The non-transitory computer-readable storage medium of claim 9, wherein in response to a determination that at least one resource provider in the cluster has met a condition for redistribution, and wherein modifying the function in the method further comprises:
identifying one or more resource providers in the cluster that support the second set of virtual infrastructure objects; and
maintaining the second set of virtual infrastructure objects on the one or more resource providers.

11. The non-transitory computer-readable storage medium of claim 10, wherein the condition for redistribution is based on a physical resource constraint of the identified one resource provider.

12. The non-transitory computer-readable storage medium of claim 10, wherein the condition for redistribution is specified by a policy.

13. The non-transitory computer-readable storage medium of claim 8, wherein the function is to balance resources in the cluster and to take at least one resource provider offline in the cluster without any manual input from a user, and the customized policy is to enable evacuating the at least one resource provider.

14. The non-transitory computer-readable storage medium of claim 13, wherein modifying the function in the method further comprises:
identifying the at least one resource provider in the cluster that supports the second set of virtual infrastructure objects; and
migrating the second set of virtual infrastructure objects to another resource provider in the cluster before taking the at least one resource provider offline.

15. An infrastructure management server configured to management virtual infrastructure objects in a cluster, comprising:
a processor; and
a non-transitory computer-readable storage medium that includes a set of instructions which, in response to execution by the processor, cause the processor to:
perform a function on the virtual infrastructure objects in the cluster;
identify a first set of virtual infrastructure objects out of the virtual infrastructure objects that are tagged;
identify a customized policy associated with a second set of virtual infrastructure objects out of the first set of virtual infrastructure objects; and
modify the function based on the customized policy.

16. The infrastructure management server of claim 15, wherein the function is to balance resources in the cluster without any manual input from a user, and the customized policy is to disable distribution of the resources in the cluster.

17. The infrastructure management server of claim 16, wherein in response to a determination that at least one resource provider in the cluster has met a condition for redistribution, and wherein instructions for modifying the function which, in response to execution by the processor, further cause the processor to:
identify one or more resource providers in the cluster that support the second set of virtual infrastructure objects; and
maintain the second set of virtual infrastructure objects on the one or more resource providers.

18. The infrastructure management server of claim 17, wherein the condition for redistribution is based on a physical resource constraint of the identified one resource provider.

19. The infrastructure management server of claim 17, wherein the condition for redistribution is specified by a policy.

20. The infrastructure management server of claim 15, wherein the function is to balance resources in the cluster and to take at least one resource provider offline in the cluster without any manual input from a user, and the customized policy is to enable evacuating the at least one resource provider.

21. The infrastructure management server of claim 20, wherein instructions for modifying the function which, in response to execution by the processor, cause the processor to:
identify the at least one resource provider in the cluster that supports the second set of virtual infrastructure objects; and
migrate the second set of virtual infrastructure objects to another resource provider in the cluster before taking the at least one resource provider offline
